(19) United States
(12) Patent Application Publication
(10) Pub. No.: US 2008/0297768 A1
(43) Pub. Date: Dec. 4, 2008

(54) Polarization Mode Dispersion Analyzer

(76) Inventors: Bogdan Szafraniec, Sunnyvale, CA (US); Calvin Bruce Ward, Castro Valley, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/756,942

(22) Filed: Jun. 1, 2007

(51) Int. Cl. G01N 21/00

(52) U.S. Cl. 356/73

(57) ABSTRACT

A polarization mode dispersion analyzer having a light source, a sensor, an output phase signal analyzer, and a controller. The light source generates a probe light signal that is intensity modulated and also polarization modulated, the light source being adapted to apply the light signal to a device under test. The sensor generates an output phase signal related to the phase of the intensity modulation of an output optical signal leaving the device under test. The output phase signal analyzer measures an amplitude and phase of at least one frequency component of the output phase signal at a frequency related to the polarization modulation. The controller generates a signal indicative of a differential group delay of the device under test utilizing the measured amplitude and phase. The controller also measures a group delay associated with the device under test.

### BACKGROUND OF THE INVENTION

Devices based on the transmission and processing of optical signals are becoming increasingly common. Computer and communication networks that utilize optical fibers for the transmission of data are now commonplace. Such networks rely on optical fibers and other elements such as light amplifiers, multiplexers, demultiplexers, dispersion compensators, etc. to carry and process the light signals.

The passage of an optical signal through devices such as optical fibers results in a delay that can vary with the state of the polarization of the light. This dependence of the propagation characteristics of light waves on the polarization state is often referred to as polarization mode dispersion (PMD). PMD can result in problems in the transmission of data at very high data rates because portions of the light signal having different polarization states will arrive at slightly different times, and hence, a light pulse used to transmit data will suffer a broadening effect that can lead to interference between successive pulses in a pulse train of data.

A knowledge of the PMD of an optical fiber and optical components is important for a number of reasons. For example, a system designer must know the magnitude of the PMD before setting the maximum data transmission rate over the fiber. Accordingly, methods for measuring PMD have been sought. In one proposed method, four independent measurements of the group delay of an optical fiber or other device under test are made with light of four different polarization states. Since the measured group delay drifts with temperature and is perturbed by vibrations, this technique suffers from environmental sensitivity, especially in long fibers. Further, the PMD is obtained by taking the difference of the large measured group delays. Hence, a small error in the measured group delays leads to a much larger error in the PMD.

### SUMMARY OF THE INVENTION

The present invention includes a polarization mode dispersion analyzer having a light source, a sensor, an output phase signal analyzer, and a controller. The light source generates a probe light signal that is intensity modulated and also polarization modulated, the light source being adapted to apply the light signal to a device under test. The sensor generates an output phase signal related to the phase of the intensity modulation of an output optical signal leaving the device under test. The output phase signal analyzer measures an amplitude and phase of at least one frequency component of the output phase signal at a frequency related to the polarization modulation. The controller generates a signal indicative of a differential group delay of the device under test utilizing the measured amplitude and phase. In one aspect of the invention, the controller also measures a group delay associated with the device under test. In another aspect of the invention, the probe light signal includes a light signal in which all three Stokes vector polarization components are periodic functions of time that are characterized by one or more modulation frequencies and wherein the at least one frequency component is one of the modulation frequencies.

### BRIEF DESCRIPTION OF THE DRAWINGS

FIG. 1 illustrates one embodiment of a polarization-mode dispersion analyzer according to the present invention.

FIG. 2A illustrates the polarization space in which the Stokes vector is defined.

FIG. 2B illustrates another method for describing the polarization of a monochromatic optical wave.

FIG. 3 is a perspective view of a polarization modulator.

FIG. 4 is a cross-sectional view through line 4-4 of the polarization modulator shown in FIG. 3.

FIG. 5 is a perspective view of a Poincare sphere.

FIGS. 6 and 7 illustrate a polarization modulated light signal that can be used in one embodiment of the present invention.

FIGS. 8 and 9 illustrate another polarization modulated light signal that can be used in an embodiment of the present invention.

FIG. 10 illustrates the voltage waveforms that produce the trajectory shown in FIG. 8.

### DETAILED DESCRIPTION OF THE PREFERRED EMBODIMENTS OF THE INVENTION

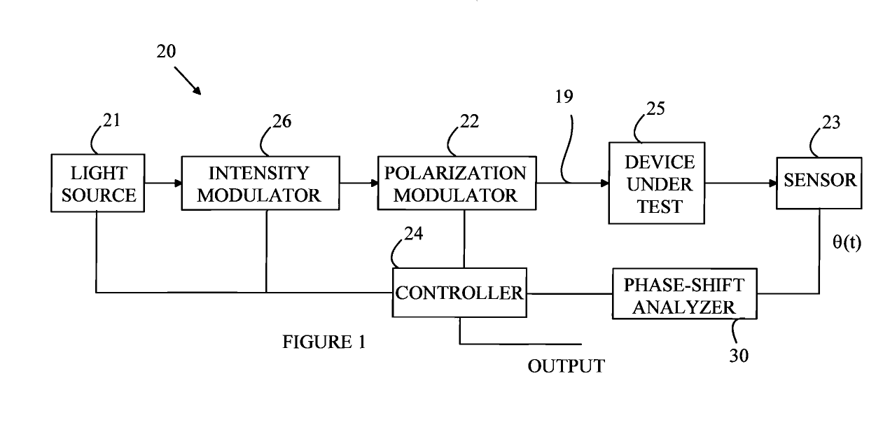

The manner in which the present invention provides its advantages can be more easily understood with reference to FIG. 1, which illustrates one embodiment of a PMD analyzer according to the present invention. Analyzer 20 generates a probe light source signal 19 that is applied to the device under test 25. The light from the device under test, either transmitted or reflected, is detected by sensor 23. The output of sensor 23 is analyzed by a phase-shift analyzer 30 and a controller 24 in the manner discussed below to determine parameters that are related to polarization mode dispersion in the device under test.

In one embodiment of the present invention, the probe light source signal is generated by a combination of light source 21, intensity modulator 26, and polarization modulator 22. Light source 21 generates a light signal having a fixed polarization state. The intensity of the optical signal from light source 21 is modulated by intensity modulator 26 at an intensity modulation frequency. The polarization of the light leaving intensity modulator 26 is modulated by polarization modulator 22 prior to the light source signal being applied to a device under test 25. The manner in which the polarization is modulated will be discussed in detail below.

The light leaving device under test 25 is input to a sensor 23 that measures the power in the light signal that leaves device under test 25 as a function of time. The sensor 23 must be capable of receiving optical signals at the intensity modulation frequency. In one embodiment, sensor 23 includes a photodetector and a synchronous detection circuit that generates in-phase and quadrature signals from the output of the photodetector. The synchronous detection circuit may operate at the intensity modulation frequency. Alternatively, the synchronous detection circuit may include an electrical mixer that mixes the electrical frequency down from the intensity modulation frequency to a lower intermediate frequency (IF). Then, the synchronous detection, implemented in hardware or software, may operate at the IF. The in-phase (I) and quadrature (Q) output of the synchronous detector provide an estimate of power (R) and phase (θ) of the received intensity modulated signal. The estimated phase θ(t) is further processed as described below. Any other arrangement that generates the phase θ(t) of the intensity modulated optical signal received by the photodetector at the intensity modulation frequency could be utilized.

The output phase signal θ(t) can be described in terms of polarization modulation frequencies. The output phase signal, θ(t), of sensor 23 is analyzed by a phase-shift analyzer 30 that measures the amplitude and phase of the frequency components contained in θ(t) at a set of frequencies that are determined by polarization modulator 22. Phase-shift analyzer 30 can include a vector spectrum analyzer, a lock-in amplifier, or any other form of synchronous detection, implemented in hardware or in software, that allows simultaneous measurement of amplitude and phase of the frequency components of θ(t) at the set of frequencies in question.

The operation of these components is under the control of controller 24 that also performs the computations needed to provide a measurement of the PMD of device under test 25. Controller 24 can be any data processing system that is also capable of generating the required potentials for the polarization modulator, reading the information from phase shift analyzer 30, and performing the computations described below. General-purpose signal generation and data processing systems or special purpose hardware can be utilized to construct such a controller.

As noted above, intensity modulator 26 modulates the light signal from light source 21 at an intensity modulation frequency fₘ. The intensity modulation frequency must be high enough to measure phase shifts related to the group delay or the differential group delay (or PMD) of the device under test. The intensity modulation frequency is typically between few MHz and few GHz. In the absence of polarization modulation by polarization modulator 22, θ is a constant. If device under test 25 has detectable PMD and the polarization state of the intensity modulated light signal is modulated appropriately by polarization modulator 22, then the observed phase will be modulated at frequencies determined by the polarization modulation. That is, θ will become a function of time, θ(t). The manner in which the PMD is derived from the observed modulation θ(t) will be explained in detail below after a discussion of the manner in which the polarization of the light signal applied to the device under test is modulated.

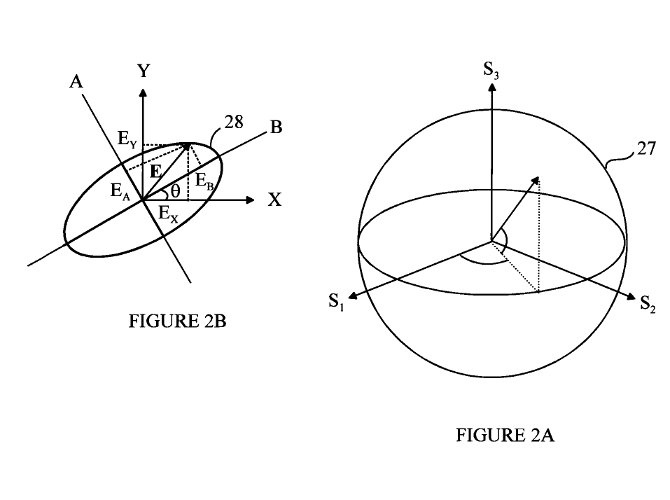

The operation of the present invention can be more easily understood in terms of the Stokes vector, which describes the state of polarization of a light signal. The Stokes vector has 4 components, S₀-S₃. The first component, S₀, is the intensity of the light signal and the remaining three components describe the state of polarization of the light signal. The polarization state of the light signal is represented as a vector in a three dimensional space in which the unit vectors along the three axes can be viewed as representing the fraction of the light with various types of polarization. The S₁ axis measures the content of linear polarization with the positive values corresponding to horizontally polarized light, and the negative values corresponding to vertically polarized light. The S₂ axis measures the content of linear polarization at 45 degrees to the horizontal (or vertical) with the positive values corresponding to +45 degree polarized light, and the negative values corresponding to −45 degree polarized light. Finally, the S₃ axis measures the content of circular polarization, the positive values representing right-hand circularly (right circular) polarized light and the negative values representing left-hand circularly (left circular) polarized light. The normalized Stokes vector has all its components normalized with respect to its first element. Thus, the normalized intensity is equal to one. Refer now to FIG. 2A, which illustrates the polarization space in which the normalized Stokes vector is defined. For a monochromatic optical signal, the polarization states of the light lie on a unit radius sphere 27 that is often referred to as the Poincare sphere.

The Stokes vector parameters can be related to the electric field of the light waves. Refer now to FIG. 2B, which illustrates another method for describing the polarization state of a monochromatic plane wave. In general, the plane wave is specified by its propagation vector and the complex amplitudes of the electric field vector in a plane perpendicular to the propagation vector. The propagation vector is perpendicular to the plane of FIG. 2B. In general, the electric field vector moves around an ellipse 28 in the plane. The path can be described in terms of an arbitrary coordinate system XY. The Stokes vector components are related to the components of the electric field vector, E, as follows:

S₀=|Eₓ|²+|E_{y}|²

S₁=|Eₓ|²−|E_{y}|²

S₂=2Re(E*ₓE_{y})

S₃=2Im(E*ₓE_{y}) (1)

It should be noted that the components of the electric field vector are complex values. It can be shown that θ(t) is related to a set of elementary parameters p₀, p₁, p₂, and p₃ by the following relationship.

$$θ ( t ) = ( {p}_{0} , {p}_{1} , {p}_{2} , {p}_{3} ) ( \begin{matrix}1 \\ q ( t ) \\ u ( t ) \\ v ( t )\end{matrix} ) \qquad ( 2 )$$

where, after appropriate scaling, p₀ represents the group delay; p₁ represents the 0° component of the differential group delay; p₂, represents the 45° component of the differential group delay, and p₃ represents the circular component of the differential group delay. Here, q(t), u(t), and v(t) are normalized Stokes vector components that are modulated, and hence, are functions of time. The parameters, pⱼ, can be related to the elementary matrices of the Jones calculus for describing polarization states. The reader is referred to Bogdan Szafraniec and Douglas Baney, “Elementary Matrix-Based Vector Optical Network Analysis” Journal of Lightwave Technology, Vol. 4, April 2007 for a detailed description of elementary matrices and elementary parameters.

Referring again to FIG. 1, polarization modulator 22 causes the polarization state of the light passing therethrough to be altered continuously in a manner determined by the electrical input signals thereto without substantially altering the power of the optical signal. For the purposes of this discussion, a polarization modulator will be defined to be a device that modulates the polarization state without substantial modulation of intensity. The insertion loss of the device is not relevant to the present invention; however, it typically is smaller than 5 dB. The action of the polarization modulator can be viewed in the Stokes vector space as causing the Stokes vector to traverse a path on the surface of the Poincare sphere. If the Stokes vector is modulated at a frequency f and one or more of the elementary parameters pⱼ for j>1, are non-zero, then the measured phase, θ(t), will also show a modulation at frequency f that can be detected by sensor 23, processed by the phase shift analyzer 30, and used by controller 24 to compute the pⱼ, provided the modulation of S satisfies certain conditions.

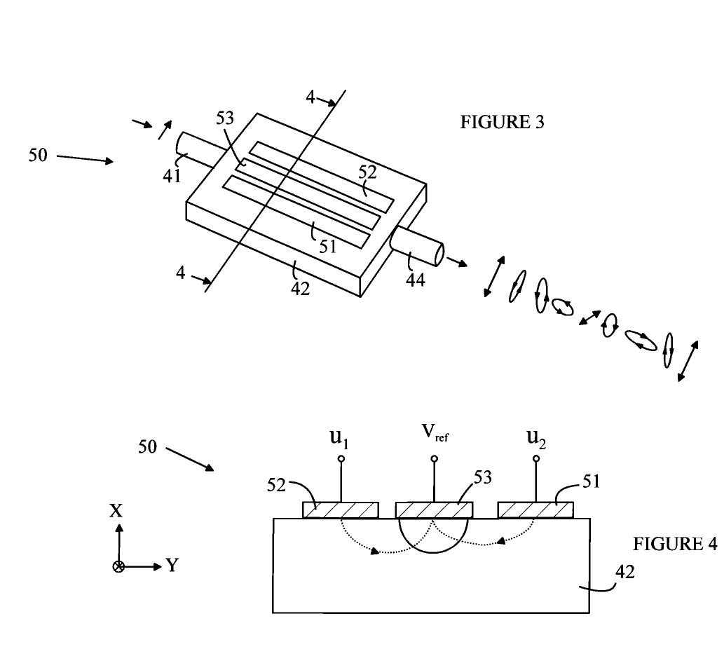

Refer now to FIGS. 3 and 4, which illustrate one class of polarization modulator that is capable of providing the modulation needed for the present invention. FIG. 3 is a perspective view of polarization modulator 50, and FIG. 4 is a cross-sectional view of polarization modulator 50 through line 4-4 shown in FIG. 3. Polarization modulator 50 is constructed from an x-cut, z-propagating LiNbO₃ 42 in which the light enters through input port 41, perpendicular to the face of the xy plane, and propagates in the z-direction. The top surface of crystal 42 includes three electrodes 51-53 that are used to apply potentials to the crystal. The potentials generate electric fields in the crystal that give rise to birefringence in the crystal. By correctly choosing the potentials, the polarization state can be altered such that the Stokes vector of the output signal can be moved to any point on the Poincare sphere.

The manner in which the potentials are chosen will be explained in more detail below. For the present discussion, it is sufficient to note that a first periodic waveform is applied between electrodes 53 and 52, and a second periodic waveform is applied between electrodes 53 and 51. Electrode 53 is a reference (ground) electrode. In general, the waveforms have the same period. Over each period of the waveforms, the Stokes vector of the output light traverses a predetermined path (trajectory) on the surface of the Poincare sphere. The path is chosen such that all of the polarization dependent components of the Stokes vector are modulated with sufficient amplitude to measure the corresponding elementary parameter, pⱼ, related to each Stokes vector component during each cycle of the applied waveforms. The path may also be chosen to have its center of gravity in the center of the sphere.

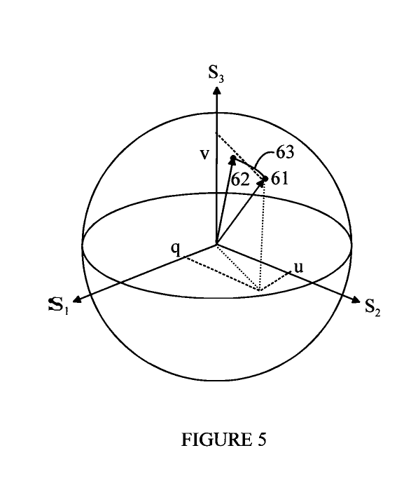

Refer now to FIG. 5, which is a perspective view of the Poincare sphere. Consider a point 61 on the Poincare sphere that is on the desired trajectory 63. The Stokes vector that ends on this point has three components along the three axes in the Stokes vector space. The components are obtained by projecting the Stokes vector onto the three axes. The three projections are shown at q, u, and v. As the Stokes vector moves to a point 62 on the desired trajectory, these components increase and decrease depending on the particular location of the point at any given time. For the purposes of this discussion, it will be assumed that that q(t), u(t), and v(t) are periodic functions. This will be the case if the desired path/trajectory is a closed loop on the Poincare sphere and that each cycle of the modulation results in the polarization state moving once around the loop. As will be discussed in more detail below, the Stokes vector components can also comprise periodic functions even when the path/trajectory on the Poincare sphere is not closed.

It should be noted, however, that while q(t), u(t) and v(t) are periodic, q(t), u(t) and v(t) cannot each be pure tones simultaneously. For the components to be pure tones, there must be three frequencies, w_{q}, wᵤ, and wᵥ, for which

q(t)=cos(ω_{q}t)

u(t)=cos(ωᵤt+Dᵤ)

v(t)=cos(ωᵥt+Dᵥ)

q²(t)+u²(t)+v²(t)=1, (3)

where Dᵤ and Dᵥ are fixed phase shifts. It can be shown that this system of equations has no solutions with these constraints.

While a solution in which each of the components is a single tone cannot be found, a solution that only depends on three tones is possible. For example,

q(t)=cos(2ωt)

u(t)=(sin(ωt)+sin(3ωt))/2

v(t)=(−cos(ωt)+cos(3ωt)/2 (4)

The above equations satisfy the constraint q(t)²+u(t)²+v(t)²=1 and describe a trajectory that produces only three tones in the signal from sensor 23.

A more detailed discussion of the considerations that go into choosing a trajectory on the Poincare sphere is provided below. For the purposes of the present discussion, it will be assumed that a trajectory for the Stokes vector on the Poincare sphere has been chosen.

Given a trajectory on the Poincare sphere, the potentials that must be applied to the electrodes in the polarization modulator must be determined. To provide these potentials for a known constant input polarization state, a calibration table that maps the voltages on the two electrodes onto polarizations on the Poincare sphere is constructed. For the purposes of this discussion, it will be assumed that the polarization modulator is a modulator such as that shown in FIGS. 3 and 4 and that electrode 53 is held at ground. The calibration table is constructed by applying a particular pair of voltages to electrodes 51 and 52 and then measuring the polarization of the light leaving port 44 using a conventional polarization analyzer that measures the three Stokes vector components.

This process can be more easily understood by referring to FIG. 5 and considering a specific example. When electrodes 51 and 52 are at ground, the polarization of the output light is at 61. When a set of two voltages is applied to electrodes 51 and 52, the Stokes vector moves to position 62. If a different set of two voltages is applied, the Stokes vector will move to some different point on the Poincare sphere. Hence, the polarization modulator can be calibrated by measuring the point on the sphere corresponding to each set of input voltages. In one embodiment, the voltage ranges are selected to cover the entire Poincare sphere. The calibration can be organized as a vector valued function of two variables, namely the two voltages on electrodes 51 and 52. Conversely, once a trajectory has been defined on the Poincare sphere, each point on the trajectory can be mapped to a pair of voltages to be applied to the electrodes. Once the sequence of voltages for each electrode is calculated, controller 24 shown in FIG. 1 can synthesize two waveforms, one for electrode 51, and one for electrode 52. Each waveform constitutes one period of a periodic modulation function that is applied to the corresponding electrode. The fundamental frequency for this periodic waveform is set to be consistent with the frequency limitations of the modulator and the power sensor.

Consider a normalized form of the Stokes vector (1, q(t), u(t), v(t)). Since the Stokes vector is modulated using a periodic modulation function, each of its components is also a periodic function. Hence, each component can be represented as a Fourier series. If the Stokes vector executes a closed loop on the Poincare sphere at an angular frequency, ω, then each component can be expanded in a Fourier series with ω as the fundamental frequency. The number of significant harmonics in the series depends on the details of the trajectory chosen on the Poincare sphere. For example, the trajectory described by Eq. (4) has only 3 significant harmonics. In the more general case, mathematically, the components of the polarization dependent components of the Stokes vector can be written in the following form

q(t)=C₁+A_{1,1}sin(ωt+φ_{1,1})+A_{1,2}sin(2ωt+φ_{1,2})+A_{1,3}sin(3ωt+φ_{1,3})

u(t)=C₂+A_{2,1}sin(ωt+φ_{2,1})+A_{2,2}sin(2ωt+φ_{2,2})+A_{2,3}sin(3ωt+φ_{2,3})

v(t)=C₃+A_{3,1}sin(ωt+φ_{3,1})+A_{3,2}sin(2ωt+φ_{3,2})+A_{3,3}sin(3ωt+φ_{3,3}) (5)

The constants Cᵢ, φ_{i,j}, and A_{i,j}, where i=1 to 3 and j=1 to N, can be measured experimentally by measuring the output of the polarization modulator for each Stokes' component using an appropriate polarization filter that removes two of the three components. The measurement can be performed using a vector spectrum analyzer, a lock-in amplifier, or any other form of synchronous detection that allows simultaneous measurement of amplitude and phase of individual harmonics. As will become clear from the following discussion, the number of harmonics that are significant, N, must be at least 3.

The above-described polarization modulation patterns all involve expanding the polarization dependent components of the Stokes vector in a harmonic series. That is, each component is expanded in terms of a number of component frequencies in which the component frequencies are integer multiples of some fundamental frequencies. However, as will be discussed in detail below, there are cases in which the polarization dependent components of the Stokes vector can be expanded in a series in which the frequencies are not integer multiples of a predetermined frequency. Hence, in the general case, it will be assumed that

q(t)=C₁+A_{1,1}sin(ω₁t+φ_{1,1})+A_{1,2}sin(ω₂t+φ_{1,2})+A_{1,3}sin(ω₃t+φ_{1,3})

u(t)=C₂+A_{2,1}sin(ω₁t+φ_{2,1})+A_{2,2}sin(ω₂t+φ_{2,2})+A_{2,3}sin(ω₃t+φ_{2,3}

v(t)=C₃+A_{3,1}sin(ω₁t+φ_{3,1})+A_{3,2}sin(ω₂t+φ_{3,2})+A_{3,3}sin(ω₃t+φ_{3,3}) (6)

As will become clear from the following discussion, there must be at least three frequencies ωⱼ. In the case of a harmonic expansion, ωⱼ=j*ω, where ω is the fundamental frequency.

Referring again to Eq. (2), the measured phase, θ(t), can be re-written in the form

θ(t)=p₀+p₁q(t)+p₂u(t)+p₃v(t) (7)

Substituting the expansion of Eq. (6) for q(t), u(t), and v(t)

$$θ ( t ) = {p}_{0} + {p}_{1} ( {C}_{1} + {\sum }_{j = 1}^{N} {A}_{1 , j} sin ( {w}_{j} t + {ϕ}_{1 , j} ) ) + {p}_{2} ( {C}_{2} + {\sum }_{j = 1}^{N} {A}_{2 , j} sin ( {w}_{j} t + {ϕ}_{2 , j} ) ) + {p}_{3} ( {C}_{3} + {\sum }_{j = 1}^{N} {A}_{3 , j} sin ( {w}_{j} t + {ϕ}_{3 , j} ) ) \qquad ( 8 )$$

where N is at least 3. It is convenient to introduce a complex notation that combines constants A_{i,j} and φ_{i,j} into a single complex constant z_{i,j}=A_{i,j} exp(jφ_{i,j}), where j=\sqrt{−1} is an imaginary number. In the complex notation equation (8) becomes

$$θ ( t ) = {p}_{0} + {p}_{1} \text{(} {C}_{1} + {\sum }_{j = 1}^{N} {z}_{1 , j} exp ( j {ω}_{j} t ) + {p}_{2} \text{(} {C}_{2} + {\sum }_{j = 1}^{N} {z}_{2 , j} exp ( j {ω}_{j} t ) + {p}_{3} \text{(} {C}_{3} + {\sum }_{j = 1}^{N} {z}_{3 , j} exp ( j {ω}_{j} t ) \qquad ( 8 b )$$

Hence, now complex θ(t) is modulated at each of the frequencies wⱼ. As noted above, phase-shift analyzer 30 shown in FIG. 1 analyzes θ(t) and extracts the components of θ(t) at three of the frequencies ωⱼ. Denote the extracted complex θ(t) at ωⱼ by θⱼ. Then, Eq. (8) can be decomposed into a system of equations of the form:

θ₀=p₀+p₁C₁+p₂C₂+p₃C₃ (9a)

and

θ₁=p₁Z_{1,1}+p₂Z_{2,1}+p₃Z_{3,1}

θ₂=p₁Z_{1,2}+p₂Z_{2,2}+p₃Z_{3,2}

θ₃=p₁Z_{1,3}+p₂Z_{2,3}+p₃Z_{3,3} (9b)

It is important to note that the equation (9b) can be rewritten in a matrix form θ=Z·p, where the matrix Z, contains elements z_{i,j}, and θ and p are vectors. In equation (9a), θ₀ is the DC component of θ(t). The constants Cⱼ are the average components of the Stokes vector over the modulation path on the Poincare sphere. They describe the unmodulated part of the light. To simplify the following discussion, it will be assumed that the polarization modulation paths on the Poincare sphere are chosen such that the average of each polarization dependent component of the Stokes vector is 0. i.e., Cⱼ=0. This choice corresponds to the depolarized light. Then, from equation (9a), θ₀=p₁, i.e., the group delay is found from the DC component of the demodulated θ(t). To be precise, the group τ_{g} is

$${τ}_{g} = \frac{{θ}_{0}}{2 π {f}_{IM}} , \qquad ( 9 c )$$

where f_{IM} is the frequency of the intensity modulation.

The system of equations shown in Eq. 9(b) will have a solution if the determinant of the matrix Z is non-zero. In this case, the values of the elementary parameters pⱼ can be determined. It is important to note that the reference phase utilized in the synchronous detection of the components of θ(t) must be properly set. In general, the reference phase is set such that the computed values of pⱼ are real numbers. The differential group delay is obtained from these parameters as follows:

DGD=\sqrt{p₁²+p₂²+p₃²}/(2πf_{IM}) (10)

where f_{IM} is the intensity modulation frequency utilized by intensity modulator 26.

The above-described embodiments utilized only three of the frequencies even in those cases in which the Stokes vector component expansion includes additional harmonics or other frequencies. However, embodiments in which more of the components are utilized to provide an over determined system in which noise is further reduced could be constructed. In addition, if the determinant of Z is 0 for some choice of the 3 frequencies and there are additional frequencies, a matrix constructed from other frequencies may have a non-zero determinant.

In the above-described embodiments the designer determines the trajectory on the Poincare sphere and generates the modulation signals that are applied to the polarization modulator from a calibration model for that polarization modulator. The coefficients of the matrix Z are then measured experimentally. If the determinant of Z is zero, or too small to allow for an accurate solution of the system of equations, a new trajectory on the Poincare sphere is chosen and the process repeated.

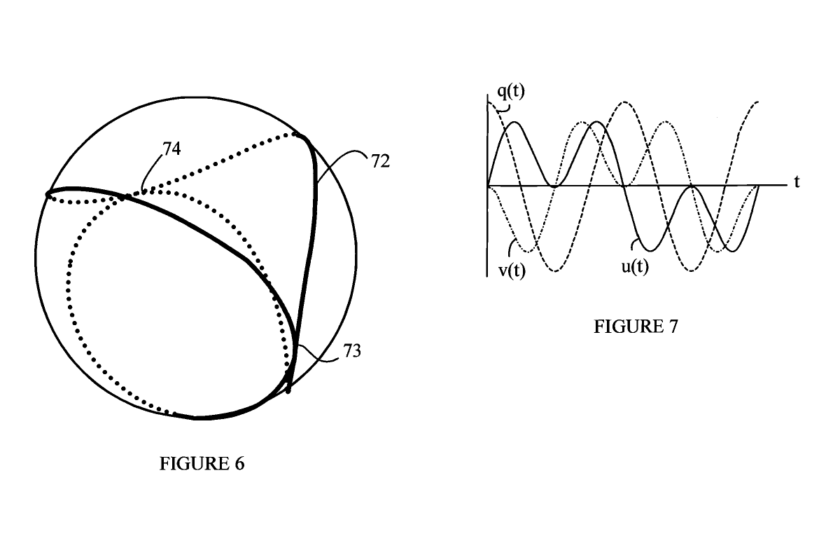

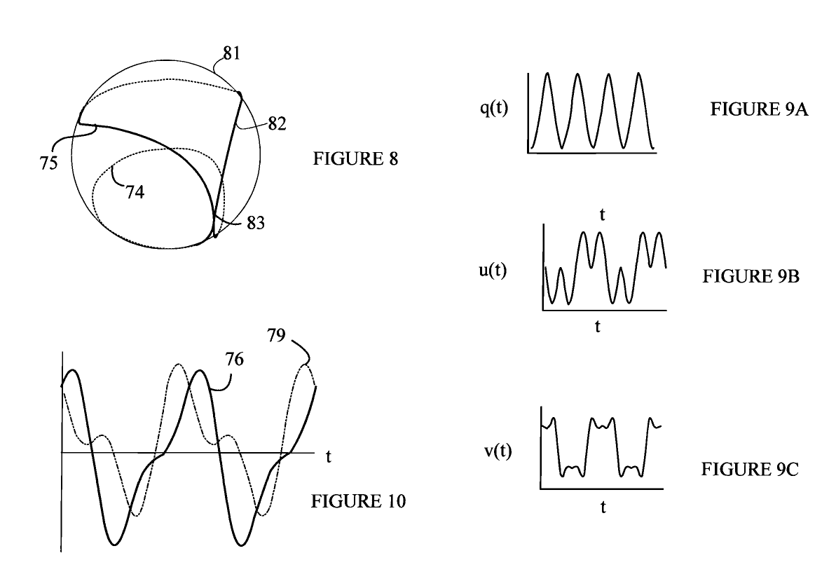

Alternatively a known trajectory as that described by the Eq. (4), discussed above, can be used. The trajectory produces only three frequencies. The corresponding Z matrix is:

$$Z = ( \begin{matrix}0 & 1 & 0 \\ - j / 2 & 0 & - j / 2 \\ - 1 / 2 & 0 & 1 / 2\end{matrix} ) \qquad ( 13 )$$

where j=\sqrt{−1}. The determinant of the above matrix is equal to j/2. Refer now to FIGS. 6 and 7, which illustrate the trajectory described by Eq. (5). FIG. 6 shows the trajectory on the Poincare sphere, and FIG. 7 is a graph of the individual Stokes vector components. Referring to FIG. 6, trajectory 72 is topologically a FIG. 8 having two loops that are joined at the two points shown at 73 and 74.

The choice of trajectory from among those that generate matrices that have non-zero determinants can be guided by some general principles that are listed below. Trajectories that generate fewer frequencies for all Stokes vector components are preferred. Only three frequencies are needed to solve for the corresponding coefficients that determine the DGD. The additional harmonics divert energy that would have gone into the harmonics that are being used; hence, trajectories that generate a significant number of additional harmonics are likely to lead to lower signal-to-noise ratios.

The number of harmonics that are generated by any given trajectory may depend on the number of harmonics in the corresponding drive signals that are applied to the electrodes in the polarization modulator. Also, complicated voltage waveforms are more difficult to synthesize, and hence, can lead to more complex driving circuitry for the modulator.

There is also a limit on the voltages that can be generated by the controller and applied to the polarization modulator. Hence, a trajectory on the Poincare sphere must be traversable using voltages that are within some predetermined range of voltages that are determined by the polarization modulator and the controller.

Refer now to FIGS. 8-9, which illustrate an exemplary trajectory that is utilized in one embodiment of the present invention. FIG. 8 is a prospective view of Poincare sphere 81. FIGS. 9A-9C illustrate the Stokes vector components generated by the polarization modulator traversing trajectory 82. Trajectory 82 is topologically a FIG. 8 path having a first loop 75 in the northern hemisphere of Poincare sphere 81 and a second loop 74 in the southern hemisphere of Poincare sphere 71. The loops meet at point 83 on the equator. Both loops are traversed clockwise as viewed by an observer located on the outside of the sphere.

The modulation of the various Stokes vector components are shown in FIGS. 9A-9C. As noted above, at least some of the Stokes vector components have modulation functions that include a number of harmonics that can be used to solve for the parameters pⱼ discussed above. Refer now to FIG. 10, which illustrates the voltage waveforms 76 and 79 that are applied to electrodes 51 and 52 shown in FIGS. 3 and 4 that cause the Stokes vector to move about trajectory 82. Voltage waveforms 76 and 79 contain two cycles and correspond to two evolutions along the trajectory. The reference electrode 53 is held at ground in this embodiment.

The above-described trajectories on the Poincare sphere are closed loops, and hence, the modulation frequencies are harmonics of the frequency with which the closed loop is traversed. For the purposes of the present discussion, a path will be defined as being closed if it begins and ends at the same point on the Poincare sphere. This will always be the case when the Stokes vector is a periodic function. In some cases, it may be advantageous to use modulation frequencies that are unrelated frequencies instead of harmonics. For example, such unrelated frequencies could reduce some errors caused by harmonics produced by non-linearities of the power sensor. Trajectories in which the Stokes vector components are modulated in a periodic manner without requiring the trajectory to be closed are possible. An example of such a trajectory is given by

q(t)=cos(2ω₁t)

u(t)=(sin(2ω₁t−ω₂t)+sin(2ω₁t+ω₂t))/2

v(t)=(cos(2ω₁t−ω₂t)+cos(2ω₁t+ω₂t))/2 (14)

with ω₁=eω/2 and ω₂=ω. Here e is the irrational number, 2.71828 . . . The controller detects modulation at (e−1)ω, eω, and (e+1)ω, where ω is chosen to provide detection at frequencies that are within the range of the analyzer contained within the controller. It should be noted that while the Stokes vector components are described by periodic functions, the trajectory defined by Eq. (14) is not periodic. The trajectory is endless and eventually samples the entire Poincare sphere surface without repeating itself.

The above-described embodiments of the present invention utilize a light source that has a fixed polarization state. The light source can be a tunable laser light source that allows characterization of components over wavelength. The fixed polarization state of the laser source is maintained within the intensity modulator and modulated by the polarization modulator. Highly monochromatic tunable laser sources are very attractive in embodiments in which the device under test includes an optical fiber, optical fiber components, or other devices having fiber interfaces or small dimensions. However, embodiments based on other light sources such as LEDs can also be constructed. If the light source does not provide light with a constant fixed polarization, a polarization filter can be introduced between the light source and the polarization modulator or as part of the input port of the polarization modulator.

The polarization modulators discussed above can modulate the polarization of the fixed polarization light source at frequencies of up to 100 kHz and in some cases 1 MHz. Hence, the DGD measurements can be made in a time that is short compared to the time periods over which the optical properties of the device under test change. In addition, the present invention does not rely on taking differences of large group delays to measure the DGD. Accordingly, the present invention provides a substantial improvement over the prior art methods discussed above.

The above-described embodiments of the present invention output the value of DGD defined in Eq. (10). However, embodiments that provide the values of the individual quantities pⱼ, or some subset thereof, can also be provided. In this regard, it should be noted that the pⱼ, for j=1 to 3 are related to the differential group delays associated with specific polarization states.

Various modifications to the present invention will become apparent to those skilled in the art from the foregoing description and accompanying drawings. Accordingly, the present invention is to be limited solely by the scope of the following claims.

What is claimed is:

1. An apparatus comprising:
a light source that generates a probe light signal that is intensity modulated and also polarization modulated said light source being adapted to apply said light signal to a device under test;
a sensor that generates an output phase signal related to the phase of the intensity modulation of an output optical signal leaving said device under test;
an output phase signal analyzer that measures at least one frequency component of said output phase signal at a frequency related to said polarization modulation; and
a controller that generates a signal indicative of a differential group delay of said device under test utilizing said measured frequency component.

2. The apparatus of claim 1 wherein said output phase signal analyzer measures an amplitude and phase of said at least one frequency component.

3. The apparatus of claim 1 wherein said controller also measures a group delay associated with said device under test.

4. The apparatus of claim 1 wherein said sensor comprises a phase sensitive detector.

5. The apparatus of claim 4 wherein said phase sensitive detector comprises a lock-in amplifier or an electrical vector spectrum analyzer.

6. The apparatus of claim 1 wherein said probe light signal comprises a light signal in which all three Stokes vector polarization components comprise periodic functions of time.

7. The apparatus of claim 6 wherein each of said periodic functions of time is characterized by one or more modulation frequencies, wherein said modulation frequencies comprise first, second, and third modulation frequencies and wherein said phase shift analyzer measures an amplitude and phase of said output light signal at each of said first, second, and third modulation frequencies.

8. The apparatus of claim 6 wherein said periodic functions of time can be characterized by no more than three modulation frequencies.

9. The apparatus of claim 7 wherein said first, second, and third modulation frequencies are not integer multiples of a common frequency.

10. The apparatus of claim 1 wherein said probe light signal is characterized by a path on a Poincare sphere and wherein said path is a closed loop.

11. The apparatus of claim 10 wherein said path is topologically a figure 8.

12. The apparatus of claim 1 said probe light signal is characterized by a path on a Poincare sphere and wherein said path is not a closed loop.

13. The apparatus of claim 1 wherein said probe light signal comprises a constant polarization component.

14. The apparatus of claim 1 wherein said light source comprises a polarized light source that generates a light signal characterized by an intensity and polarization, an intensity modulator that modulates said intensity of said light signal and a polarization modulator that modulates said polarization of said light signal.

15. The apparatus of claim 14 wherein said polarization modulator comprises a LiNbO₃ crystal having a plurality of electrodes on a surface thereof and wherein said controller further comprises a signal generator for applying periodic potentials to said electrodes.

16. A method for measuring a quantity related to a differential group delay characterizing a device under test, said method comprising:
applying a probe light signal to said device under test, said probe light being intensity modulated and polarization modulated;
determining an output phase signal related to a phase of the intensity modulation of an output optical signal leaving said device under test;
measuring at least one frequency component of the said output phase signal at a frequency related to said polarization modulation; and
generating a signal indicative of a differential group delay of said device under test utilizing said measured frequency component.

17. The method of claim 16 wherein measuring said at least one frequency component comprises measuring an amplitude and phase of that frequency component.

18. The method of claim 16 wherein said probe light signal comprises a light signal in which all three Stokes vector polarization components comprise periodic functions of time.

19. The method of claim 16 wherein said probe light signal is generated by passing a light signal having a fixed polarization through a polarization modulator that alters said fixed polarization in a manner determined by signals applied to said light modulator and wherein said method further comprises determining a calibration mapping that provides a relationship between said signals and said alterations in said fixed polarization.

20. The method of claim 16 wherein said amplitudes and phases are measured with a device having a reference phase and wherein said reference phase is set such that coefficients related to a differential group delay characterizing said device under test that are determined from said amplitude and phase are real numbers.
